(19) United States
(12) Patent Application Publication
(10) Pub. No.: US 2005/0123708 A1
(43) Pub. Date: Jun. 9, 2005

(54) [EASILY TEARABLE FILM AND METHOD FOR PREPARING THE SAME]

(76) Inventors: Su-Chen Chen, Taipei (TW); Cheng-Kang Kao, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/708,366

(22) Filed: Feb. 26, 2004

(30) Foreign Application Priority Data
Dec. 5, 2003 (TW) 92134288

(51) Int. Cl. G09F 3/00

(52) U.S. Cl. 428/43

(57) ABSTRACT

An easily tearable film and a method for preparing the same are described. The easily tearable film includes a unidirectionally tearable film with several cutting lines thereon. Each cutting line has a first end point and a second end point, and has a joining point with an imaginary straight line parallel to the tearing direction that passes the first end point of the next cutting line. The easily tearable film can be easily torn in a direction different from the tearing direction of the unidirectionally tearable film because of the cutting lines.

### CROSS REFERENCE TO RELATED APPLICATIONS

This application claims the priority benefit of Taiwan application serial no. 92134288, filed Dec. 5, 2003.

### BACKGROUND OF INVENTION

1. Field of the Invention

The present invention relates to an easily tearable film and a method for preparing the same. More particularly, the present invention relates to an easily tearable film made from a unidirectionally tearable film, such as, a uniaxially oriented film, and a method for preparing the same. The easily tearable film can be easily torn in a direction different from the tearing direction of the unidirectionally tearable film.

2. Description of the Related Art

A unidirectionally tearable film is a film having a single tearing direction, which features that the force needed to tear the film in the tearing direction is much smaller than the force needed to tear the film in any other direction. Such a unidirectionally tearable film is applicable to various industries, and can be used as, for example, a packing material of electronic products or foods, or stationery supplies.

However, since a unidirectionally tearable film has only one tearing direction, its application is limited. For example, a unidirectionally tearable film can be used to prepare a “Post-it” product, which has an advantage that a piece of any required size can be easily torn off from it. Nevertheless, since the unidirectionally tearable film has only one tearing direction, the dimensional variation is restricted to only one direction. Therefore, the use of such a Post-it product is not so flexible.

### SUMMARY OF INVENTION

In view of the foregoing, this invention provides an easily tearable film that can be easily torn in a direction different from the tearing direction of the unidirectionally tearable film, so as to promote applications of unidirectionally tearable films in various industries.

This invention also provides a method for preparing an easily tearable film that can be easily torn in more than one directions.

The easily tearable film of this invention includes a unidirectionally tearable film with multiple cutting lines thereon. The unidirectionally tearable film has a tearing direction. Each cutting line has a first end point and a second end point, and has a joining point with an imaginary straight line parallel to the tearing direction that passes the first end point of the next cutting line.

The above unidirectionally tearable film can be a uniaxially oriented film, a synthetic paper sheet or a plant fiber film.

According to a preferred embodiment of this invention, each cutting line on the easily tearable film can be a straight line or a curved line, while several cutting lines can be arranged along a straight line, a curved line or other type of specially designed line that will result in a desired edge shape directly after the film is torn apart along the cutting lines. In addition, the distance between two adjacent cutting lines and the shape of each cutting line both can be uniform or variable.

In the method of preparing an easily tearable film of this invention, a unidirectionally tearable film having a tearing direction is provided. Multiple cutting lines are then formed on the unidirectionally tearable film. Each cutting line has a first end point and a second end point, and has a joining point with an imaginary straight line parallel to the tearing direction that passes the first end point of the next cutting line.

According to a preferred embodiment of this invention, the cutting lines can be formed on the unidirectionally tearable film with a rolling method, a pressing method, an etching method, a water knife, an air knife, scissors, dispenser or laser.

Since the cutting lines are formed on the easily tearable film with the aforementioned arrangement, the easily tearable film of this invention can be easily torn in a direction different from the tearing direction of the unidirectionally tearable film. Therefore, the unidirectionally tearable film that was originally tearable in only one direction can be used more flexibly to meet various requirements.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically illustrates a top view of an easily tearable film according to a preferred embodiment of this invention.

FIG. 2 schematically illustrates a top view of an easily tearable film according to another preferred embodiment of this invention.

FIG. 3 schematically illustrates a top view of an easily tearable film according to yet another preferred embodiment of this invention, wherein the arrangement of the cutting lines is changed.

FIG. 4 schematically illustrates a top view of an easily tearable film according to still another preferred embodiment of this invention, wherein the shape of each cutting line is changed.

FIG. 5 shows a flow chart of preparing an easily tearable film according to a preferred embodiment of this invention.

### DETAILED DESCRIPTION

FIG. 1 schematically illustrates a top view of an easily tearable film according to a preferred embodiment of this invention. The easily tearable film 100 is constituted of a unidirectionally tearable film 104 with multiple cutting lines 102 formed thereon, wherein the unidirectionally tearable film 104 is, for example, a uniaxially oriented film. Each cutting line 102 has a first end point 101a and a second end point 101b, and the first/second end point 101a/b is adjacent to the second/first end point 101b/a of a neighboring cutting line 102. The unidirectionally tearable film 104 has a tearing direction 106, and the force needed to tear the film 104 in the tearing direction 106 is much smaller than the force needed to tear the film 104 in any other direction.

On the easily tearable film 100, each cutting line 102 has a joining point with an imaginary straight line 108 parallel to the tearing direction 106 that passes the first end point 101a of the next cutting line 102. In this embodiment, the joining point is exactly the second end point 101b of the cutting line 102. Therefore, when the easily tearable film 100 is being torn in a direction different from the tearing direction 106, the unidirectionally tearable film 104 is split from the second end point 101b of a cutting line 102 to the first end point 101a of the next cutting line 102 along the corresponding straight line 108. By repeating the splitting process between two cutting lines 102, it is easily to tear the unidirectionally tearable film 104 in a direction different from the tearing direction 106.

The material of the unidirectionally tearable film 104 may be a uniaxially oriented polymer, and the polymer is selected from the group consisting of nylon, polyvinyl alcohol (PVA), polyester, polyethylene terephthalate (PET), polypropylene (PP), polyethylene (PE), polycarbonate (PC), polystyrene (PS), polysulfone, polyimide (PI) and polyvinyl chloride (PVC).

The unidirectionally tearable film 104 may also be made from synthetic paper, which is selected from the group consisting of PP synthetic paper, polyester synthetic paper and PE synthetic paper.

In addition, the unidirectionally tearable film 104 may be a plant fiber film.

Moreover, the easily tearable film 100 may further include an adhesive layer (not shown) on the surface of the unidirectionally tearable film 104, so that the easily tearable film 100 can stick to an object after it is torn. The adhesive layer can be a solvent sensitive adhesive layer, a pressure sensitive adhesive layer or a heat sensitive adhesive layer. It is also feasible to print various patterns on the easily tearable film 100, so that the easily tearable film 100 can be used as a material for advertisement purpose, a personal token or a personalized product. Moreover, the unidirectionally tearable film 104 may be a uniaxially oriented film having a thickness smaller than or equal to 0.25 mm, or a uniaxially oriented sheet that has a thickness exceeding 0.25 mm.

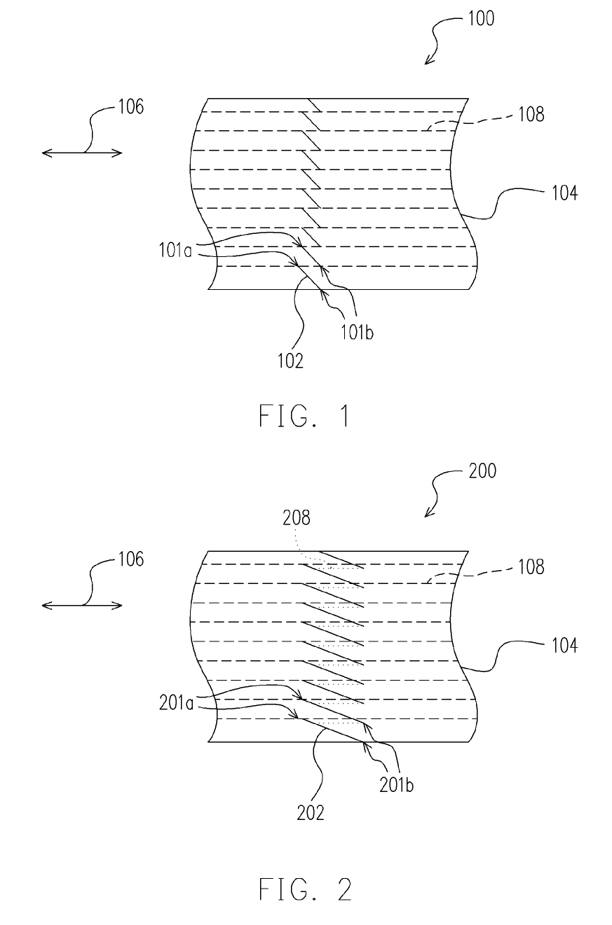

In another embodiment, the joining point of a cutting line with an imaginary straight line parallel to the tearing direction that passes the first end point of the next cutting line is not the second end point of the cutting line. Referring to FIG. 2, the easily tearable film 200 is constituted of a unidirectionally tearable film 104 and has a tearing direction 106 as above, while the imaginary straight lines 108 parallel to the tearing direction 106 are also shown. However, the joining point of a cutting line 202 with an imaginary straight line 108 parallel to the tearing direction 106 that passes the first end point 201a of the next cutting line 102 is not the second end point 201b of the cutting line 202. Accordingly, when the easily tearable film 200 is being torn in a direction different from the tearing direction 106, the unidirectionally tearable film 104 is split from the second end point 201b of a cutting line 202 to the next cutting line 202 along a straight line 208, which does not pass the first end point 201a of the next cutting line 202.

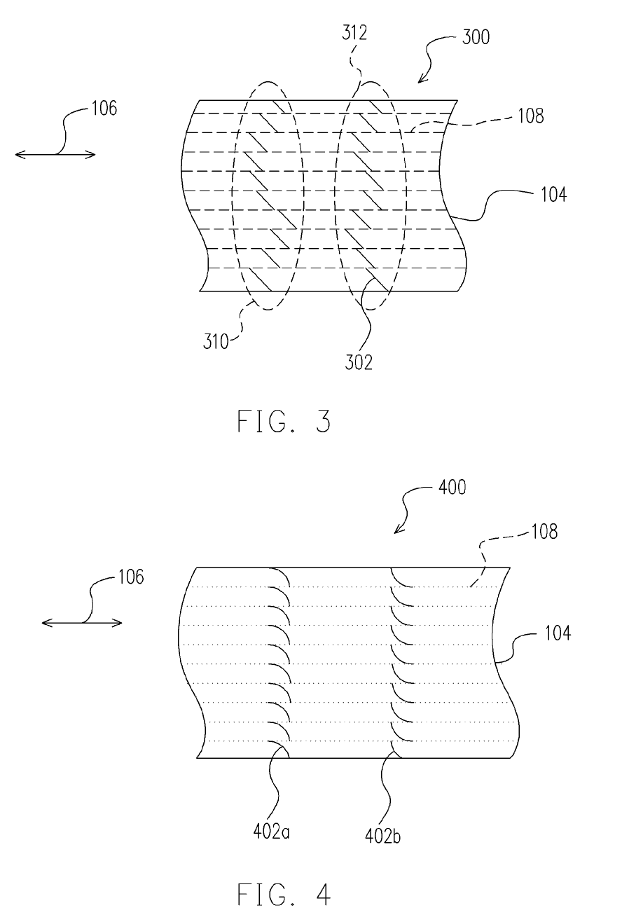

Moreover, there can be some alternatives in the arrangement of the cutting lines on the easily tearable film of this invention. Referring to FIG. 3, the easily tearable film 300 is constituted of a unidirectionally tearable film 104 and has a tearing direction 106 as above, while the imaginary straight lines 108 parallel to the tearing direction 106 are also shown. However, the cutting lines 302 are arranged along a curved line (in the region 310) or a zigzag line (in the region 312), rather than a straight line as shown in FIG. 1. Except the above examples, the cutting lines can also be arranged along other specially designed line that will result in a required edge shape directly after the film is torn apart.

Furthermore, the shape of the cutting lines on the easily tearable film of this invention can also be changed. Referring to FIG. 4, the easily tearable film 400 is constituted of a unidirectionally tearable film 104 and has a tearing direction 106 as above, while the imaginary straight lines 108 parallel to the tearing direction 106 are also shown. However, the cutting lines 402a and 402b are curved lines, rather than straight lines (102) as shown in FIG. 1. Moreover, the shape of each cutting line on the same easily tearable film 400 can be uniform or variable as required.

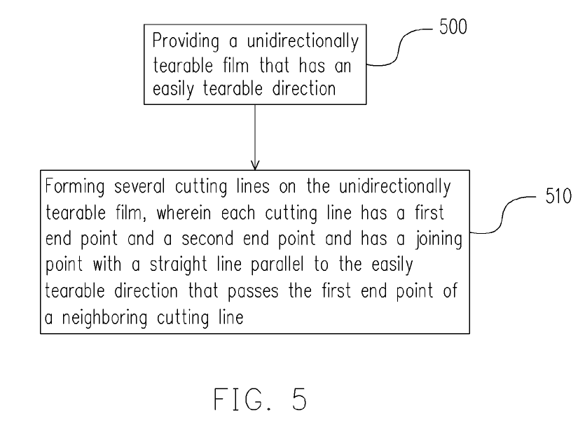

On the other hand, a flow chart of preparing an easily tearable film according to this invention is shown in FIG. 5. In step 500, a unidirectionally tearable film having a tearing direction is provided, wherein the examples of the material of the unidirectionally tearable film are described above. The step 500 may be followed by other steps, such as a step of forming an adhesive layer on the surface of the unidirectionally tearable film. When an adhesive layer is formed on the easily tearable film, it can stick to an object after being torn apart.

In the subsequent step 510, multiple cutting lines are formed on the unidirectionally tearable film. Each cutting line has a first end point and a second end point, and has a joining point with an imaginary straight line parallel to the tearing direction that passes the first end point of the next cutting line. The joining point can be the second end point of the cutting line (FIG. 1), or a point between the first end point and the second end point (FIG. 2). The cutting lines can be formed on the unidirectionally tearable film with a rolling method, a pressing method, an etching method, a water knife, an air knife, scissors, dispenser or laser.

As mentioned above, since the cutting lines having the aforementioned arrangement are formed on the easily tearable film, the film can be easily torn in a direction different from the tearing direction of the unidirectionally tearable film. Therefore, the unidirectionally tearable film that was originally tearable in only one direction can be used more flexibly to meet various requirements.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. An easily tearable film, comprising a unidirectionally tearable film with a plurality of cutting lines thereon, wherein
the unidirectionally tearable film has a tearing direction; and
each cutting line has a first end point and a second end point, and has a joining point with an imaginary straight line parallel to the tearing direction that passes the first end point of a next cutting line.

2. The easily tearable film of claim 1, wherein the joint point is the second end point of the cutting line.

3. The easily tearable film of claim 1, wherein the joint point is a point between the first end point and the second end point of the cutting line.

4. The easily tearable film of claim 1, wherein each cutting line is a straight line or a curved line.

5. The easily tearable film of claim 1, wherein the cutting lines are arranged along a straight line, a curved line or a zigzag line.

6. The easily tearable film of claim 1, wherein the shape of each cutting line is uniform or variable.

7. The easily tearable film of claim 1, wherein the unidirectionally tearable film is a uniaxially oriented polymer film that comprises a polymer selected from the group consisting of nylon, polyvinyl alcohol (PVA), polyester, polyethylene terephthalate (PET), polypropylene (PP), polyethylene (PE), polycarbonate (PC), polystyrene (PS), polysulfone, polyimide (PI) and polyvinyl chloride (PVC).

8. The easily tearable film of claim 1, wherein the unidirectionally tearable film is a uniaxially oriented polymer film, synthetic paper or a plant fiber film.

9. The easily tearable film of claim 8, wherein the synthetic paper is selected from the group consisting of polypropylene synthetic paper, polyester synthetic paper and polyethylene synthetic paper.

10. The easily tearable film of claim 1, further comprising an adhesive layer on a surface of the unidirectionally tearable film.

11. The easily tearable film of claim 10, wherein the adhesive layer is a solvent sensitive adhesive layer, a pressure sensitive adhesive layer or a heat sensitive adhesive layer.

12. A method for preparing an easily tearable film, comprising:
providing a unidirectionally tearable film that has a tearing direction; and
forming a plurality of cutting lines on the unidirectionally tearable film, wherein each cutting line has a first end point and a second end point and has a joining point with an imaginary straight line parallel to the tearing direction that passes the first end point of a next cutting line.

13. The method of claim 12, wherein the joint point is the second end point of the cutting line.

14. The method of claim 12, wherein the joint point is a point between the first end point and the second end point of the cutting line.

15. The method of claim 12, wherein the cutting lines are formed on the unidirectionally tearable film with a rolling method, a pressing method, an etching method, a water knife, an air knife, scissors, dispenser or laser.

16. The method of claim 12, wherein the unidirectionally tearable film is a uniaxially oriented polymer film that comprises a polymer selected from the group consisting of nylon, polyvinyl alcohol (PVA), polyester, polyethylene terephthalate (PET), polypropylene (PP), polyethylene (PE), polycarbonate (PC), polystyrene (PS), polysulfone, polyimide (PI) and polyvinyl chloride (PVC).

17. The method of claim 12, wherein the unidirectionally tearable film is a uniaxially oriented polymer film, synthetic paper or a plant fiber film.

18. The method of claim 17, wherein the synthetic paper is selected from the group consisting of polypropylene synthetic paper, polyester synthetic paper and polyethylene synthetic paper.

19. The method of claim 12, further comprising forming an adhesive layer on a surface of the unidirectionally tearable film.

20. The method of claim 19, wherein the adhesive layer is a solvent sensitive adhesive layer, a pressure sensitive adhesive layer or a heat sensitive adhesive layer.
